(19) United States
(12) Patent Application Publication
(10) Pub. No.: US 2026/0181417 A1
(43) Pub. Date: Jun. 25, 2026

(54) METHODS TO SUPPORT AI/ML OPERATION UNDER VARIABLE WTRU CONDITIONS

(71) Applicant: InterDigital Patent Holdings, Inc., Wilmington, DE (US)

(72) Inventors: Dylan Watts, Montreal (CA); Oumer Teyeb, Montreal (CA); Patrick Tooher, Montreal (CA); Yugeswar Deenoo Narayanan Thangaraj, Chalfont, PA (US); Moon IL Lee, Melville, NY (US); Brian Martin, Farnham (GB); Virgil Comsa, Montreal (CA)

(73) Assignee: InterDigital Patent Holdings, Inc., Wilmington, DE (US)

(21) Appl. No.: 18/990,318

(22) Filed: Dec. 20, 2024

(51) Int. Cl. H04W 24/02; H04W 8/22; H04W 88/02

(52) U.S. Cl. CPC H04W 24/02; H04W 8/22; H04W 88/02

(57) ABSTRACT

A WTRU may send an indication to a network entity. The indication may include an indication that the WTRU is configured to support WTRU configuration adaptation related to one or more communication capabilities. The WTRU may receive a plurality of configurations. The plurality of configurations may be associated with the one or more communication capabilities. The WTRU may apply a first configuration associated with the one or more communication capabilities. The WTRU may determine to change the first configuration based on a change in a WTRU status, for example by at least a threshold amount. The WTRU status may be associated with one or more of power and/or processing resources. The WTRU may apply a second configuration based on the determination to change the first configuration. The WTRU may send an indication that the second configuration has been applied to the network entity.

### BACKGROUND

Artificial Intelligence/Machine Learning (AI/ML) may be integrated into 5G NR, for example to enhance air-interface performance (e.g., improved throughput, robustness, accuracy or reliability, etc.) and/or to reduce complexity/overhead. Selected features based on an assessment of their performance in comparison with traditional methods and the associated potential standards impact include AIML for beam management, positioning, and CSI prediction.

### SUMMARY

Systems and methods are disclosed for configuration, capability reporting, and/or indication of support for configuration adaptation to support AI/M, for example for varying WTRU conditions. Conditions may include support for AI/ML operation. Configuration adaptation of WTRU configurations may be based on varying WTRU conditions. There may be an initial configuration and/or criteria to adapt a WTRU configuration. A WTRU may receive of an initial configuration, criteria, and/or a trigger for example for management and/or adaptation of a configuration. For example, WTRU assistance information and/or capability reporting may support the initial and/or the adapted configuration. The trigger and/or criteria for adapting the WTRU configuration, for example under varying WTRU conditions, may be provided (e.g., included) based on a WTRU request/preference. Configuration adaptation may support AI/ML, for example under varying conditions. For example, the WTRU may adapt an initial configuration under varying WTRU conditions and/or provide (e.g., subsequent) confirmation. The WTRU may determine and/or apply a (e.g., revised) configuration. The WTRU may support temporary adaptation and/or manage a configuration, for example after adaptation of a configuration.

A WTRU may send an indication, for example to a network entity. The indication may include an indication that the WTRU is configured to support WTRU configuration adaptation related to one or more communication capabilities. The WTRU may receive, for example in response to the indication, a plurality of configurations. The plurality of configurations may be associated with the one or more communication capabilities. The WTRU may apply a first configuration of the plurality of configurations associated with the one or more communication capabilities. The WTRU may determine to change the first configuration based on a change in a WTRU status, for example by at least a threshold amount. For example, the WTRU may indicate a capability under normal operation of 4 MIMO layers and of 2 MIMO layers when the WTRU status is overheating. In another example, the WTRU may indicate a capability of operating with a bandwidth of X MHz under normal operation and Y MHz when in a low power mode. The network may send associated configurations, for example 4 MIMO layer configuration, 2 MIMO layer configuration, X MHz bandwidth configuration, and/or Y MHz bandwidth configuration to the WTRU. The WTRU may determine the change in WTRU status, for example overheating and/or low power mode. The WTRU may (e.g., then) apply the associated configuration, for example the 2 MIMO layer configuration and/or the Y MHz bandwidth configuration. The WTRU status may be associated with one or more of power and/or processing resources. The WTRU may apply a second configuration of the plurality of configurations, for example based on the determination to change the first configuration. The WTRU may send an indication that the second configuration has been applied, for example to the network entity.

The one or more communication capabilities may include a first communication capability and a second communication capability. For example, the first communication capability may be different than the second communication capability. The first communication capability may be associated with multiple input multiple output (MIMO) layers and/or the second communication capability is associated with a bandwidth (BW). The first communication capability may correspond to a first artificial intelligence/machine learning (AI/ML) model functionality and/or the second communication capability may correspond to a second AI/ML model functionality. For example, the first AI/ML model functionality may be different than the second AI/ML model functionality.

The plurality of configurations may include a configuration for model training, a configuration for artificial intelligence/machine learning (AI/ML) model inference, a configuration for performance monitoring, a configuration for data collection, a configuration for applicability reporting, and/or a configuration for supporting WTRU operation. The WTRU status may include a heat of the WTRU, a power consumption of the WTRU, a battery level of the WTRU, and/or processing of the WTRU. The indication that the WTRU is configured to support WTRU configuration adaptation related to one or more communication capabilities may include a first indication associated with a first capability of the WTRU and/or a second indication associated with a second capability of the WTRU. The first capability and the second capability may include different communication capabilities affecting processing and/or power.

The WTRU may apply the second configuration by changing at least one value of the first configuration such that the first configuration is changed to the second configuration. The first capability may be associated with a normal power state of the WTRU and/or the second capability may be associated with a low power state of the WTRU. The WTRU may store the second configuration in the memory, for example based on an indication from a network. The WTRU may determine the change in the WTRU status. The WTRU may send, for example to a network, an indication of the determination of the change in the WTRU status. The WTRU may receive, for example from the network, the second configuration in response to the indication of the determination of the change in the WTRU status.

The WTRU may send, for example to the network, a request to apply the second configuration. The WTRU may receive, from the network, a response indicating that the WTRU can apply the second configuration. The WTRU may compare a first processing and/or power value associated with the first configuration to a second processing and/or power value associated with the second configuration. The WTRU may determine to change the first configuration to the second configuration based on the comparison. The WTRU may send, for example to a network, an indication of the comparison of the first processing and/or power value to the second processing and/or power value.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

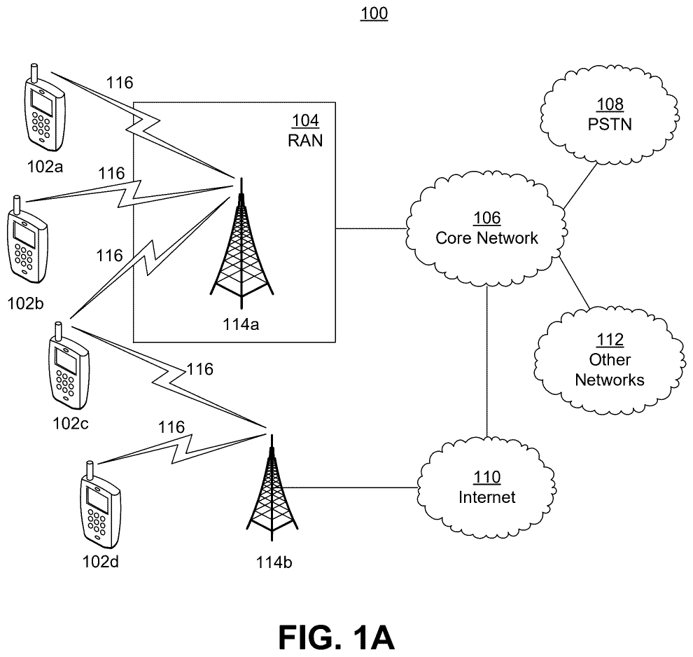

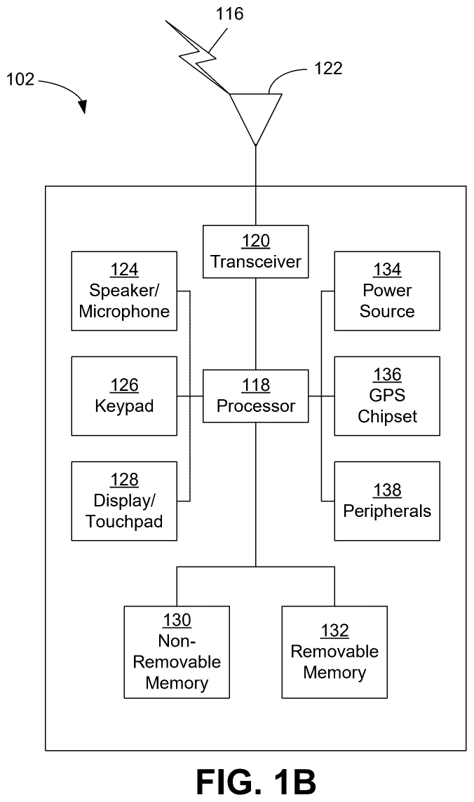

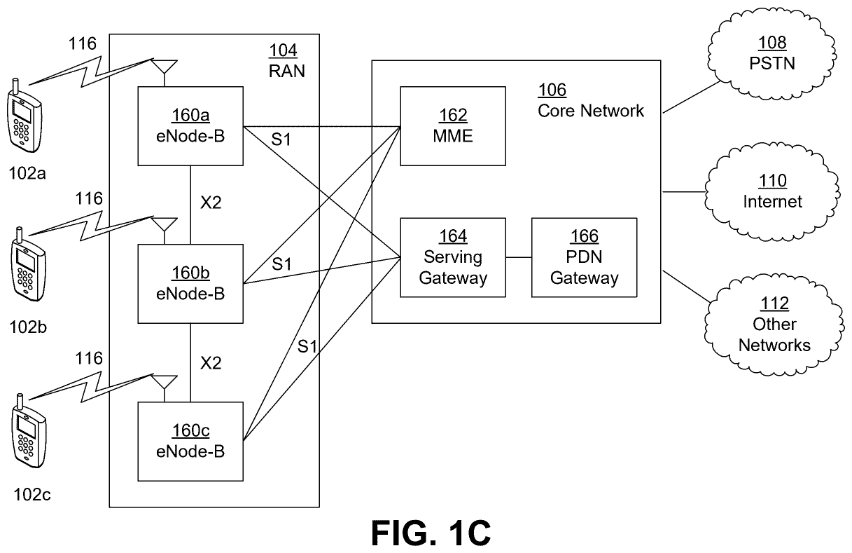

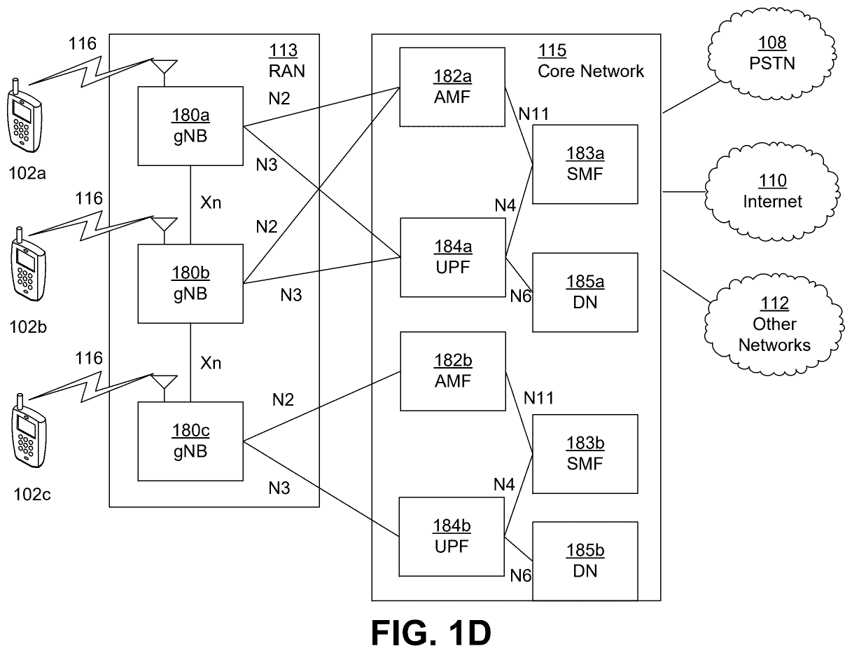

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114 a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11 ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

Systems and methods are disclosed for configuration, capability reporting, and/or indication of support for configuration adaptation to support AI/M, for example for varying WTRU conditions. Conditions may include support for AI/ML operation. Configuration adaptation of WTRU configurations may be based on varying WTRU conditions. There may be an initial configuration and/or criteria to adapt a WTRU configuration. A WTRU may receive of an initial configuration, criteria, and/or a trigger for example for management and/or adaptation of a configuration. For example, WTRU assistance information and/or capability reporting may support the initial and/or the adapted configuration. The trigger and/or criteria for adapting the WTRU configuration, for example under varying WTRU conditions, may be provided (e.g., included) based on a WTRU request/preference. Configuration adaptation may support AI/ML, for example under varying conditions. For example, the WTRU may adapt an initial configuration under varying WTRU conditions and/or provide (e.g., subsequent) confirmation. The WTRU may determine and/or apply a (e.g., revised) configuration. The WTRU may support temporary adaptation and/or manage a configuration, for example after adaptation of a configuration.

A WTRU may send an indication, for example to a network entity. The indication may include an indication that the WTRU is configured to support WTRU configuration adaptation related to one or more communication capabilities. The WTRU may receive, for example in response to the indication, a plurality of configurations. The plurality of configurations may be associated with the one or more communication capabilities. The WTRU may apply a first configuration of the plurality of configurations associated with the one or more communication capabilities. The WTRU may determine to change the first configuration based on a change in a WTRU status, for example by at least a threshold amount. The WTRU status may be associated with one or more of power and/or processing resources. For example, the WTRU may indicate a capability under normal operation of 4 MIMO layers and of 2 MIMO layers when the WTRU status is overheating. In another example, the WTRU may indicate a capability of operating with a bandwidth of X MHz under normal operation and Y MHz when in a low power mode. The network may send associated configurations, for example 4 MIMO layer configuration, 2 MIMO layer configuration, X MHz bandwidth configuration, and/or Y MHz bandwidth configuration to the WTRU. The WTRU may determine the change in WTRU status, for example overheating and/or low power mode. The WTRU may (e.g., then) apply the associated configuration, for example the 2 MIMO layer configuration and/or the Y MHz bandwidth configuration. The WTRU may apply a second configuration of the plurality of configurations, for example based on the determination to change the first configuration. The WTRU may send an indication that the second configuration has been applied, for example to the network entity.

The one or more communication capabilities may include a first communication capability and a second communication capability. For example, the first communication capability may be different than the second communication capability. The first communication capability may be associated with multiple input multiple output (MIMO) layers and/or the second communication capability is associated with a bandwidth (BW). The first communication capability may correspond to a first artificial intelligence/machine learning (AI/ML) model functionality and/or the second communication capability may correspond to a second AI/ML model functionality. For example, the first AI/ML model functionality may be different than the second AI/ML model functionality.

The plurality of configurations may include a configuration for model training, a configuration for artificial intelligence/machine learning (AI/ML) model inference, a configuration for performance monitoring, a configuration for data collection, a configuration for applicability reporting, and/or a configuration for supporting WTRU operation. The WTRU status may include a heat of the WTRU, a power consumption of the WTRU, a battery level of the WTRU, and/or processing of the WTRU. The indication that the WTRU is configured to support WTRU configuration adaptation related to one or more communication capabilities may include a first indication associated with a first capability of the WTRU and/or a second indication associated with a second capability of the WTRU. The first capability and the second capability may include different communication capabilities affecting processing and/or power.

The WTRU may apply the second configuration by changing at least one value of the first configuration such that the first configuration is changed to the second configuration. The first capability may be associated with a normal power state of the WTRU and/or the second capability may be associated with a low power state of the WTRU. The WTRU may store the second configuration in the memory, for example based on an indication from a network. The WTRU may determine the change in the WTRU status. The WTRU may send, for example to a network, an indication of the determination of the change in the WTRU status. The WTRU may receive, for example from the network, the second configuration in response to the indication of the determination of the change in the WTRU status.

The WTRU may send, for example to the network, a request to apply the second configuration. The WTRU may receive, from the network, a response indicating that the WTRU can apply the second configuration. The WTRU may compare a first processing and/or power value associated with the first configuration to a second processing and/or power value associated with the second configuration. The WTRU may determine to change the first configuration to the second configuration based on the comparison. The WTRU may send, for example to a network, an indication of the comparison of the first processing and/or power value to the second processing and/or power value.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. Theone or more emulation devices may be test equipment. Direct RF coupling and/or wireless communications via RF circuitry (e.g., which may include one or more antennas) may be used by the emulation devices to transmit and/or receive data.

Multiple features may enable a common AI/ML management framework, for example including signaling and protocol aspects of life cycle management (LCM), signaling/mechanism(s) for LCM to facilitate model training, inference, performance monitoring, data collection for both wireless transmit/receive unit (WTRU)-sided and network (NW)-sided models, and/or signaling mechanism of applicable functionalities/models

AI/ML framework may consider functionality-based LCM. A functionality may refer to an AI/ML feature enabled by a configuration. A network may indicate activation, deactivation, fallback, and/or switching of AI/ML functionality via 3GPP signaling (e.g., RRC, MAC-CE, DCI). To support the configuration and activation or deactivation of a functionality, a WTRU may report whether a functionality is applicable, for example based on WTRU and/or network-side additional conditions (e.g., WTRU speed, number of antennas etc.) and/or model availability at the WTRU. A WTRU may be provided with a configuration and/or report whether the functionality is applicable based on the configuration. The WTRU may report one or more applicable functionalities and/or subsequently receive a configuration.

Systems and methods for adaptation to support an AI/ML operation, for example under variable WTRU condition, are disclosed herein. Herein the terms adapt and/or adaptation may refer to modifying a configuration, for example modifying a first configuration to a second configuration. The terms adapt and/or adaptation may additionally or alternatively refer to replacing a configuration, for example replacing a first configuration with a second configuration.

A processing load to implement AI/ML functionality may be considerable and/or may vary from model to model. Activating an AI/ML functionality and/or model with a high demand on WTRU resources, such as power consumption and/or processing load, may cause negative effects on the WTRU hardware and/or software, such as causing the WTRU to overheat, which may impacting other aspects of the WTRU system performance and/or throughput. A WTRU may have a model trained under different WTRU conditions (e.g., normal and/or low power), for example for a (e.g., given) functionality. A (e.g., each) WTRU may have a different set of requirements/capabilities related to a configuration. Capabilities herein may include communication capabilities that may affect one or more WTRU resources, such as processing and/or power resources. For example, the communication capabilities may include DRX, number of CC/BW/MIMO layers and/or other communication capabilities. Enhancements may (e.g., therefore) be useful to adapt the WTRU configuration (e.g., based on the requirements of the AI/ML model), for example to support continued AI/ML operation under varying WTRU conditions.

Applicability of a model may be related to WTRU and/or network (NW) side conditions and/or model availability. An overheating indication (e.g., via UAI) may not distinguish the cause (e.g., due to AI/ML operation) and/or may not guarantee any action by the network to address the issue and/or modify the configuration. Reporting the model as not applicable and/or (e.g., directly) deactivating the model may be inefficient, for example as the WTRU may still be able to operate the AI/ML functionality (e.g., with adapted parameters).

Systems and methods disclosed herein address support of adaptation of a WTRU configuration to accommodate AI/ML operation, for example under different WTRU conditions (e.g., normal and/or low power operation). A WTRU may indicate capabilities, for example in one or more sets. For example, the WTRU may indicate a first set of capabilities and/or a second set of capabilities. The first set and/or second set of capabilities may be associated with one or more functionalities. The WTRU may receive a first configuration associated with the first set of (e.g., reported) capabilities and/or a second configuration associated with the second set of capabilities. The WTRU may apply a (e.g., first) configuration associated with the first set of capabilities. Additionally, or alternatively, the WTRU may store the second configuration associated with the second set of capabilities. The WTRU may detect a change in WTRU status (e.g., a change greater than a threshold). For example, the WTRU status may relate to power and/or processing resources (e.g., the WTRU begins to overheat). The WTRU may (e.g., then) report that the WTRU cannot continue operation according to the (e.g., first) configuration associated with the first set of capabilities. The WTRU may (e.g., then) apply the stored (e.g., second) configuration associated with a second set of capabilities and/or continue an AI/ML operation. The term configuration herein may refer to a configuration to support AI/ML.

A WTRU may send an indication of a capability, for example to a network (e.g., base station). The indication may indicate (e.g., via WTRU capability signaling) a first and/or second set of capabilities, for example associated with a functionality (e.g., corresponding to different power requirements of different models). Example capabilities may include differences in one or more communication capabilities, such as DRX configuration, MaxCCs, MaxBW-FR1/FR2, and/or MaxMIMOLayersFR1/FR2. The configurations may be associated with the same capability in some examples. For example, the WTRU may apply a number (e.g., 2) of MIMO layers for a first (e.g., DRX) configuration and may apply a number (e.g. 4) of MIMO layers for a second (e.g., DRX) configuration.

The WTRU may report AI/ML functionality applicability, for example to the network. The WTRU may receive a configuration to support the AI/ML functionality. For example, the configuration may include one or more AI/ML features to be collected during data collection/preprocessing for being input during training or inference of AI/ML models. In another example, the configuration may be associated with other AI/ML functionality (e.g., inference, performance monitoring, etc.). The WTRU may receive a first configuration (e.g., CC1, BW1, MIMO layers1 etc.) associated with the first set of capabilities (e.g., a “normal power” configuration). The WTRU may receive a second configuration (e.g., CC2, BW2, MIMO layers2 etc.) associated with a second set of capabilities (e.g., a “low power” configuration).

The WTRU may apply the configuration associated with a first set of capabilities. The WTRU may report, for example via a RRC Reconfiguration complete message, that the WTRU is currently operating according to the first set of capabilities. The WTRU may store the second configuration associated with the second set of capabilities.

The WTRU may detect an event and/or change in WTRU status (e.g., greater than a threshold). The WTRU status may be associated with power and/or processing resources. The WTRU may (e.g., then) report that the WTRU may not continue applying AI/ML related configuration according to the first set of capabilities. For example, the WTRU capabilities may be reduced due to AI/ML operation. The AI/ML operation may utilize (e.g., additional) processing power such that the WTRU may determine to apply another configuration. For example, the WTRU may determine to apply a 2 MIMO layer configuration (e.g., from a 4 MIMO layer configuration) based on the WTRU status change (e.g., use of additional processing power for the AI/ML operation). Example events and/or (e.g., WTRU) statuses may include overheating due to excessive power consumption, a low battery mode, overloaded computation, and/or a processing complexity, etc. The WTRU may alternatively or additionally indicate a preference to operate according to a second set of capabilities. For example, the WTRU may indicate the preference to operate according to the second set of capabilities if the same performance is achievable by a lower-power model associated with second set of capabilities.

The WTRU may receive a corresponding action from network, for example regarding AI/ML operation. For example, the network may confirm that the WTRU may switch to the second configuration associated with the second set of capabilities. The network may provide the second configuration, for example if the second configuration is not already stored at WTRU. The network may switch, modify, and/or deactivate the AI/ML functionality. The WTRU may transmit a confirmation (e.g., via a RRC Reconfiguration Complete message) that the corresponding change in configuration has been applied.

The processing load of AI/ML may be large. Power consideration may (e.g., therefore) be a key metric. Alignment between the WTRU and network on aspects related to AI/ML information is important, for example including the impacts of AI/ML models on other aspects of the WTRU, in order to avoid negatively impacting other system performance.

Systems and methods disclosed herein support adaptation of a WTRU configuration to accommodate an AI/ML operation under different WTRU conditions. A configuration and/or a capability may be for continued AI/ML operation under different WTRU conditions. A WTRU may be provided with one or more configurations to support AI/ML operation under a WTRU condition change. Examples may include configurations to support an AI/ML operation and/or adaptation and management of a WTRU configuration (e.g., to support AI/ML operation under varying WTRU conditions).

Configuration adaptation to support AI/ML operation under varying WTRU conditions may be initiated if supported by (e.g., both) the WTRU and/or network (NW). A WTRU may indicate capability for one or more aspects of configuration adaptation to support AI/ML operation, for example under varying WTRU conditions. For example, the WTRU may send an indication of the capability prior to initiation of the procedure and/or reception of associated configurations. A NW may indicate support (e.g., per cell) for one or more aspects of configuration adaptation to support an AI/ML operation, for example under varying WTRU conditions. A WTRU may, for example, initiate a procedure and/or expect configuration with a cell which support the procedure.

Systems and methods disclosed herein support an indication of a WTRU capability, NW support, and/or reception of one or more configurations to support configuration adaptation to support AI/ML operation under varying WTRU conditions. A capability and/or network support for configuration adaption to support an AI/ML operation under varying conditions may be described herein.

A capability may be used for configuration adaptation to support AI/ML operation under varying WTRU conditions. The capability may be related to one or more (e.g., all) aspects of configuration adaptation to support AI/ML operation under varying WTRU conditions. Support for configuration adaptation to support AI/ML operation under varying WTRU conditions may be reported by the WTRU and/or indicated by the network (e.g., on a cell-specific basis).

A WTRU may indicate capability and/or support for one or more aspects of configuration adaptation to support AI/ML operation under varying WTRU conditions. For example, the WTRU may indicate a (e.g., single) capability to indicate support for one or more (e.g., all) aspects of configuration adaptation to support AI/ML operation under varying WTRU conditions. Additionally, or alternatively, the WTRU may report support for one or more (e.g., each) aspect of configuration adaptation to support AI/ML operation under varying WTRU conditions. For example, the WTRU may indicate support for reporting multiple sets of capabilities, storing one or more configurations (e.g., associated with a set of capabilities), adapting a WTRU configuration based on AI/ML LCM, adapting a WTRU configuration based on satisfaction of one or more conditions, WTRU-autonomous configuration adaptation, temporary adaptation of WTRU configuration, and/or configuration management after adaptation.

The WTRU may report the one or more capabilities of configuration adaptation to support AI/ML operation under varying WTRU conditions, for example, via a WTRU capability transfer procedure. For example, the WTRU may indicate capability and/or support via random access, upon radio resource control (RRC) establishment, upon request from the network, and/or WTRU assistance information. The WTRU may indicate the capability and/or support via random access, via one or more dedicated resources, via random access preamble partitioning, for example a set of reserved preambles or random access occasions, and/or radio network identifiers (RNTIs), etc. The WTRU may indicate the capability and/or support upon RRC connection establishment/resumption, for example by Msg3 or Msg5. The WTRU may indicate the capability and/or support upon a request from the network, for example upon reception of a capability enquiry message.

A capability to support/perform/execute/initiate one or more aspects of configuration adaptation to support AI/ML operation under varying WTRU conditions may be reliant/linked to one or more other configurations. For example, the network may determine (e.g., assume) that a WTRU is capable of one or more aspects of configuration adaptation to support AI/ML operation under varying WTRU conditions. The network may determine (e.g., assume) that a WTRU is capable of one or more aspects of configuration adaptation based on an activation, a state, and/or a configuration. The configuration may include a configuration of an AI/ML model and/or functionality, an activation of an AI/ML model and/or functionality, and/or availability of an AI/ML model and/or functionality.

The capabilities may be based on one or more characteristics of the WTRU. Example characteristics may include performance of an AI/ML model and/or functionality, WTRU speed, remaining WTRU power, WTRU processing ability, WTRU location, and/or a service. The characteristics of the WTRU location may include a WTRU location within a certain set of cells, a set of specific beams (e.g., used by the WTRU), and/or GPS location, etc. The service may include an indication of when a particular type of service is in use, for example related to one or more specific network slices or QCIs.

A procedure may be (e.g., temporarily) disabled. The procedure may be (e.g., temporarily) disabled for example if an associated configuration is not present and/or active, WTRU characteristics are not suitable, and/or the WTRU is configured for configuration adaptation to support AI/ML operation under varying WTRU conditions. For example, a WTRU may perform a data transfer and may (e.g., then) determine to apply another configuration based on running an AI/ML model. The configuration may not support the data transfer and the WTRU may (e.g., then) disable the data transfer procedure. In some examples, the WTRU may not initiate the procedure and/or the procedure may be inactive. The WTRU may indicate (e.g., subject to configuration) to the network that configuration adaptation to support AI/ML operation under varying WTRU conditions is (e.g., temporarily) disabled and/or inactive, for example via a MAC CE, UCI, and/or RRC signaling. Additionally, or alternatively, the WTRU may report an indication of a reason for the procedure being disabled and/or inactive. For example, the indication may indicate that a joint configuration is disabled and/or that the WTRU characteristics are not suitable.

There may be network support for configuration adaptation to support an AI/ML operation, for example under varying WTRU conditions. The network may indicate support for configuration adaptation to support AI/ML operation under varying WTRU conditions. Support for configuration adaptation to support AI/ML operation under varying WTRU conditions may be indicated per cell, per PLMN, per frequency, per tracking area (TA), and/or per RAN notification area (RNA). The indication may include a flag and/or a bit in system information which, for example may indicate support for configuration adaptation to support AI/ML operation under varying WTRU conditions. The NW may indicate support for an aspect of the procedure, for example that the cell supports network-controlled configuration adaptation and/or does not support WTRU autonomous configuration adaptation. Additionally, or alternatively, the network may indicate (e.g., within system information and/or via RRC configuration) a list of one or more cells, for example which support configuration adaptation to support AI/ML operation under varying WTRU conditions.

In some examples the WTRU may (e.g., only) initiate configuration adaptation to support AI/ML operation under varying WTRU conditions and/or one or more aspects of configuration adaptation to support AI/ML operation under varying WTRU conditions when the network supports the procedure. For example, the WTRU may (e.g., only) resume AI/ML operation upon return to RRC connected if the cell has indicated support for configuration adaptation to support AI/ML operation under varying WTRU conditions.

Configurations to support AI/ML operation are disclosed herein. The WTRU may receive a configuration to support one or more AI/ML operations. Example configurations may include a configuration for model training, inference, performance monitoring, data collection, and/or applicability reporting. In an example, one or more AI/ML features to be collected during data collection/preprocessing for being input during training or inference of AI/ML models, performance of the AI/ML models may be monitored for updating performance.

The configuration may be for model training. The WTRU may receive the configuration for AI/ML model training. Example configurations for model training may include criteria for updating a model, criteria for determining when a model is done training, criteria for downloading a new model, criteria for re-training a model, and/or a configuration to train a model (e.g., duration of training, and/or number of iterations etc.).

The configuration may be for AI/ML inference. The WTRU may receive a configuration for AI/ML inference. Example configurations for inference may include an indication of a model in which to perform inference, information characteristics for input, NW-side (e.g., additional) conditions, and/or an associated identifier (ID) of the model (e.g., trained model).

The configuration may be for performance monitoring. The WTRU may a receive configuration for AI/ML performance monitoring. Examples configuration for performance monitoring may include an indication of when to perform performance monitoring (e.g., periodicity, duration etc.), criteria for performance monitoring (e.g., thresholds), and/or criteria to report performance monitoring results (e.g., performance has dropped below a threshold).

The configuration may be for data collection. The WTRU may receive a configuration for AI/ML data collection. Example configurations for data collection may include a measurement configuration, an associated ID(s), NW-side (e.g., additional) conditions, limits on the amount of data collected, types of data, status, and/or events to collect, a trigger to report collected data, and/or a format to report collected data.

The configuration may be for applicability reporting. The WTRU may receive a configuration for AI/ML applicability reporting. Example configurations for applicability reporting may include an indication of whether to proactively or reactively report the applicability, an indication of whether the WTRU may report non-applicability, an indication of whether the WTRU may transmit an update during the connected regarding the applicability of a model, and/or a trigger (e.g., trigger condition) to report applicability (e.g., a functionality becomes non-applicable).

A configuration may be adapted to support WTRU operation, for example in varying conditions. The WTRU may receive a one or more configurations which may be adapted to support WTRU operation under varying conditions (e.g., to address WTRU issues such as overheating). The WTRU may apply a configuration by changing one or more values and/or capabilities associated with the configuration. The values and/or capabilities may be communication capabilities and/or may affect processing and/or power. Example values and/or capabilities which may be changed to support WTRU operation may include a maximum number of component carriers, a maximum bandwidth, a maximum multiple input multiple output (MIMO) layers, a discontinuous reception (DRX), a modulation and coding scheme (MCS), and/or AI/ML related configurations (e.g., as described herein).

The values and/or capabilities may be used as input into an AI/ML model (e.g., during training or implementation/inference). Training the model may include identifying one or more features for being input to the AI/ML model, a target output, and updating parameters/hyperparameters during the training process and based on iterations of training data to train the parameters/hyperparameters of the model to achieve a desired performance related to the target. The input (e.g., values and/or capabilities) to the model during training and/or implementation/inference may be measured (e.g., by the WTRU) and/or received from another device (e.g., a network). The input may be preprocessed or directly input into the AI/ML model (e.g., as raw data). The model may be trained at the WTRU for implementation thereon, or one or more portions thereof (e.g., parameters/hyperparameters/etc.) may be received from the network.

A configuration may support adaptation and/or management. The WTRU may receive a configuration to support WTRU adaptation and/or management to support AI/ML operation under varying WTRU conditions. Example configurations for adaptation and/or management may include a (e.g., initial) set of one or more configurations, a trigger to modify a configuration based on WTRU conditions, and/or the application and/or confirmation of WTRU adaptation.

A configuration may be for initial configuration management. The WTRU may receive a configuration for initial configuration management. Examples configurations for initial configuration management may include an indication (e.g., a flag and/or bit) to enable the WTRU to provide additional assistance information, an indication (e.g., a flag and/or bit) indicating that the WTRU may store multiple configurations, criteria for configuration management (e.g., release, maintain etc.), and/or support for implicit configuration adaptation (e.g., based on life cycle management (LCM)).

A configuration may be for triggering configuration adaptation. The WTRU may receive a configuration for triggering configuration adaptation. Example configurations for triggering adaptation may include a condition to adapt an AI/ML-related configuration, an indication of whether the WTRU may notify the network prior to configuration adaptation, an indication of whether the WTRU may request to update/switch a configuration, an indication of whether to include additional assistance information within a WTRU update request, and/or an indication of whether to include the resulting impact of not fulfilling a WTRU update request.

A configuration may be for the application and/or confirmation of WTRU configuration adaptation. The WTRU may receive a configuration for the application and/or confirmation of WTRU configuration adaptation. Example configurations for the application and/or confirmation of WTRU configuration adaptation may include an indication (e.g., a flag or bit) which enables WTRU-autonomous adaptation of configuration, an indication of whether the WTRU may request and/or require network confirmation prior to applying the configuration, and/or an indication of whether the WTRU may apply the configuration (e.g., temporarily).

Initial configuration and/or adaptation criteria is disclosed herein. WTRU power consumption (e.g., significant power consumption) and/or processing resources may be utilized for supporting AI/ML operation, for example depending on the functionality and/or model used to perform the A/ML operation. A WTRU may (e.g., therefore) have different capabilities (e.g., MIMO layers, and/or BW, etc.) that may be implemented for example depending on the type of AI/ML model and/or functionality currently operating.

Systems and methods disclosed herein may support reception and/or management of an initial configuration, criteria to adapt the (e.g., initial) configuration, and/or a trigger to adapt the (e.g., initial) configuration. For example WTRU assistance information and/or capability reporting may support an initial configuration, an adapted configuration, criteria to adapt a configuration, and/or a trigger to adapt a WTRU configuration (e.g., under varying WTRU conditions, including based on WTRU request/preference).

The WTRU may receive an initial configuration and/or one or more other configurations (e.g., to support WTRU adaptation based on varying conditions). One or more of the other configurations may be applied, for example based on WTRU assistance information, applicability reporting, and/or capability signaling. The network may additionally or alternatively indicate which configurations to apply and/or which configurations to be stored (e.g., if the WTRU receives more than one configuration).

Systems and methods disclose WTRU assistance and/or capability information, for example for configuration management. The WTRU may provide information to the network, for example to support configuration for the WTRU under varying conditions. The WTRU may provide the information as capability signaling, AI/ML applicability reporting, WTRU assistance information, radio resource control (RRC) signalling, medium access control (MAC) control element (CE), uplink control information (UCI), non-access stratum (NAS), and/or random access channel (RACH) signaling. The information may include an indication of one or more (e.g., sets of) capabilities associated with the WTRU. For example, the WTRU may provide one or more sets of capabilities associated with different WTRU conditions and/or scenarios. The WTRU may provide an associated set of capabilities corresponding to a WTRU in one or more WTRU states. Example states may include a WTRU low power mode, WTRU overheating, WTRU high-mobility, WTRU low mobility, WTRU stationary, WTRU under high processing load, and/or WTRU under low processing load.

The WTRU may have an associated set of capabilities for an AI/ML model and/or functionality. The WTRU may provide the information (e.g., capabilities), for example as AI/ML capability reporting and/or applicability reporting. For example, the WTRU may provide a first set of capabilities associated with a first AI/ML model and/or functionality. Additionally, or alternatively, the WTRU may provide a second set of capabilities associated with a second AI/ML model and/or functionality.

The WTRU may have multiple states associated to a specific functionality, for example if the WTRU supports more than one model for a given functionality. The WTRU may report one or more sets of capabilities associated with a functionality. The WTRU may provide such information as assistance information. For example, the WTRU may provide (e.g., via WTRU assistance information message) a preferred set of configurations associated with a particular WTRU scenario (e.g., overheating, low power state, high processing load etc.).

The WTRU may indicate a current WTRU status, for example additionally or alternatively to providing the WTRU capabilities associated with a (e.g., particular) WTRU state, characteristic, and/or associated AI/ML model/functionality. For example, the WTRU may provide a set of capabilities associated with normal operation, low power operation, and/or overheating operation. The WTRU may additionally or alternatively provide an indication that the WTRU is (e.g., currently) operating in a normal power mode. The WTRU may indicate the associated set of capabilities and the WTRU state in the same message (e.g., within WTRU capability signalling). In some examples the WTRU may send each indication via separate messages. For example the WTRU may send the initial set of capabilities with WTRU capability reporting, and (e.g., then) send the current WTRU state via WTRU assistance information.

Signaling of configuration adaptation to support AI/ML operation under varying WTRU conditions is disclosed herein. The WTRU may be provided with configurations and/or (e.g., configuration) associated adaptations to support AI/ML operation under varying WTRU conditions, for example upon establishment and/or resumption of an RRC connection (e.g., within the RRC Setup/Resume message), upon handover to another cell (e.g., within a HO command/RRC reconfiguration message with a reconfiguration with sync), and/or at any time during an active RRC connection (e.g., RRC reconfiguration message without reconfiguration with sync). Additionally, or alternatively, a configuration for adaptation to support AI/ML operation under varying WTRU conditions may be indicated, configured, and/or provided via SIB (e.g., a new SI block, or within another existing SIB), NAS, MAC CE, DCI, RACH (e.g., MSG2, MSG4, MSGB), RRC, and/or PDCCH/PUSCH.

The WTRU may receive (e.g., different) information and/or components of a configuration for adaptation to support AI/ML operation under varying WTRU conditions via different signaling methods. For example, the WTRU may receive dedicated configuration aspects via RRC signalling (e.g., fallback and/or a second configuration to maintain), and/or other configurations and/or information via system information. If a WTRU is provided with a dedicated configuration and/or indication related to configuration adaptation to support AI/ML operation under varying WTRU conditions for example, the WTRU may override other (e.g., common) configuration information (e.g., received via broadcast signalling) and/or may combine the dedicated configuration with (e.g., common) configuration information. In some examples, the WTRU may use the most recently received information in the configuration, for example regardless of signalling method.

The WTRU may receive one or more (e.g., alternative) configurations, for example using a signalling method (e.g. via system information or dedicated RRC signaling). The network may select and/or indicate which of the one or more alternative configurations to apply, for example using another type of signalling (e.g. via dedicated RRC signalling or MAC CE). The WTRU may receive an initial set of one or more configurations, for example in response to WTRU capability reporting, applicability reporting, and/or WTRU assistance information. If the WTRU receives multiple configurations for example, the network may explicitly indicate which configuration should be applied upon connection (e.g., activated) and/or which configurations should be stored (e.g., deactivated). In some example a (e.g., each) configuration may be associated with (e.g., additional) information (e.g., regarding how the WTRU should handle the configuration). Examples of (e.g., additional) information may include an indication the configuration should be applied as a default configuration, an indication the configuration should be stored, an associated set of criteria for activating the configuration, an associated set of criteria for deactivating the configuration, and/or an associated set of criteria for releasing the configuration. The WTRU may apply a configuration or set of configurations, for example based on satisfaction of one more associated conditions for application (e.g., as described herein).

In some examples, which set of configurations to be applied may be indicated implicitly (e.g., via activation of an associated configuration). The WTRU may provide an applicability report for a given functionality, for example including the associated set of capabilities the WTRU may operate under while running the given AI/ML model. The network may respond by providing a configuration corresponding to a particular model, providing multiple configurations corresponding to multiple models with an indication of which configuration/model to activate, and/or providing multiple configurations corresponding to different models. The network may additionally, or alternatively, allow the WTRU to select which configuration to apply, for example based on the selected model. If the WTRU autonomously selects the configuration provided by the network for example, the WTRU may (e.g., further) report such information upon application of the configuration.

The WTRU may send an indication that the configuration has been applied. The WTRU may send the indication to the network. For example, the WTRU may confirm (e.g., via the RRC Reconfiguration complete, RRC Setup complete, RRC Reestablishment complete and/or RRC Resume complete messages) that the WTRU has applied the configuration, for example upon reception and/or application of one or more configurations. The WTRU may additionally or alternatively indicate (e.g., within the confirmation) which set of configurations have been applied, and/or which set of configuration(s) have been stored. The WTRU may release related configurations for supporting AI/ML operation under varying WTRU conditions (e.g., all or one or more parts of a configuration). For example the WTRU may release the related configuration when the current serving cell does not support configuration adaptation to support AI/ML operation under varying WTRU conditions. Additionally, or alternatively, the WTRU may release the related configuration when the WTRU does not have an active, available, configured, and/or supported AI/ML functionality/model to adapt the WTRU configuration.

Criteria and/or triggers for configuration adaptation are disclosed herein. The WTRU may detect a change in AI/ML operation, performance, and/or WTRU condition (e.g., WTRU begins to overheat, etc.), which for example may trigger (e.g., the need for) a change in configuration. A change in configuration may be based on a pre-configured set of criteria associated with a configuration and/or WTRU request for example.

WTRU configuration adaptation may be based on AI/ML operation and/or LCM. The WTRU may switch configuration based on AI/ML operation and/or aspects of AI/ML LCM. For example, the WTRU may have a configuration and/or set of configurations associated with an AI/ML functionality and/or an AI/ML model (e.g., based on WTRU capabilities associated with operation of the AI/ML model/functionality previously indicated). Upon activation of the AI/ML functionality and/or model for example, the WTRU may adapt a configuration according to the associated configuration and/or set of configurations. The WTRU may de-configure the configuration and/or set of configurations associated with the AI/ML model/functionality, for example upon deactivation of an AI/ML model. Additionally, or alternatively, he WTRU may apply a fallback and/or default value, and/or the network may explicitly indicate an alternative configuration (e.g., linked to or within the AI/ML deactivation message itself).

The WTRU may adapt a configuration based on the performance of one or more AI/ML models and/or functionalities. For example, the WTRU may evaluate the performance of an activated AI/ML model/functionality. If the performance of the AI/ML model falls below a performance criterion for example, the WTRU may adapt a configuration (e.g., to attempt to improve the performance of the AI/ML model). The WTRU may increase maximum bandwidth, a number of MIMO layers, and/or number of component carriers, for example to enable additional inputs to an AI/ML model to improve the output. Alternatively, or additionally, if the performance of an AI/ML model and/or functionality exceeds a criteria and/or threshold for example, the WTRU may adapt the configuration (e.g., the balance performance with power consumption). If the AI/ML model/functionality exceeds a performance criterion for example, the WTRU may adapt the configuration and/or request to revise the configuration. For example the WTRU adapt the configuration and/or request to revise the configuration to reduce the supported bandwidth, a number of MIMO layers, and/or a number of component carriers (e.g., to further improve WTRU power saving).

The WTRU may adapt a configuration based on availability and/or applicability of an AI/ML model and/or functionality. For example, the WTRU may receive (e.g., have received) a configuration or set of configurations associated with a particular model and/or functionality. If the functionality and/or model becomes unavailable for example (e.g., the model is not trained, and/or the functionality becomes non-applicable), the WTRU may adapt and/or release the associated configuration. The WTRU may request an updated and/or revised configuration and/or set of configurations to support the new model, for example if a model and/or functionality becomes available (e.g., the WTRU has sufficiently trained or downloaded a new model) and/or if a previously non-applicable functionality and/or model becomes applicable.

Triggers and/or criteria to switch a WTRU configuration based on WTRU characteristics are disclosed herein. A WTRU may adapt (e.g., change) one or more aspects of a configuration based on the WTRU characteristics. Examples WTRU characteristics may include WTRU speed, WTRU position, WTRU power, WTRU battery level, WTRU processing capability, WTRU load, and/or WTRU buffer status. The WTRU may modify one or more aspects of the current configuration and/or apply a new configuration, for example upon detection of change in WTRU characteristics. WTRU detection of (e.g., which) aspects of the configuration to change may be based on conditions associated with the configuration and/or aspects of the configuration. For example, the WTRU may be provided with one or more thresholds. If a threshold is exceeded or if a value has fallen below a threshold for example, the WTRU may apply an alternative configuration and/or value for the same configuration.

The WTRU may detect that a data collection buffer has become full and/or is about to become full. The WTRU may (e.g., therefore) revise the AI/ML data collection configuration to a measurement configuration with fewer measurement resources (e.g., since the WTRU may not need to log or has fewer resources available to store the logged data). The WTRU may have recently reported collected data, for example freeing up space in the data collection buffer. The WTRU may (e.g., then) apply an adapted data collection configuration which, for example may support additional measurement resources (e.g., to more quickly acquire the necessary data).

The WTRU may indicate that criteria and/or a trigger condition has been fulfilled. The WTRU may autonomously apply the adapted configuration and/or notify the network after configuration application, for example upon satisfaction of one or more criteria and/or triggers. Additionally, or alternatively, the WTRU may update the configuration implicitly, for example upon activation of an associated AI/ML model/functionality. The WTRU may notify the network upon satisfaction of one or more triggering criteria and/or triggers, for example prior to modification of any configuration. A notification may include an indication (e.g., a flag and/or bit) that a triggering condition and/or criteria for configuration adaptation has been satisfied, which configuration may be modified, whether the WTRU has a stored and/or available configuration to adapt the current configuration, whether the WTRU needs additional configuration by the network to adapt configuration, and/or a cause and/or details related to the trigger and/or criteria which has been satisfied. The network may perform confirmation actions (e.g., as described herein), for example upon reception of an indication that a triggering condition and/or criteria for configuration adaptation has been satisfied.

The WTRU may request to operate with a (e.g., specific) configuration or set of configurations. The request may be to switch to a (e.g., already) stored set of configurations, and/or to receive a (e.g., different) set of configurations. If the performance of an AI/ML model exceeds requirements for example, the WTRU may request a less processing and/or power intensive configuration (e.g., which may still support the required performance criteria). A request for configuration adaptation may include an indication (e.g., a flag and/or bit) that a WTRU is requesting an adapted configuration, which configuration may be modified, whether the WTRU has a stored and/or available configuration to adapt the current configuration, whether the WTRU needs additional configuration by the network to adapt configuration, and/or a preferred value and/or configuration.

The WTRU may include assistance information within a configuration request and/or a preference indication (e.g., to support the network determination to adapt the configuration and/or how to adapt the configuration). Examples of assistance information include a cause of the WTRU request (e.g., an issue with the WTRU such as overheating, or a more power efficient configuration is available), whether the adaption will impact AI/ML performance, and/or whether the configuration adaption will impact WTRU performance. The WTRU may include an indication of an (e.g., resulting) impact of not revising the configuration (e.g., would be). For example, the WTRU may indicate that the WTRU may not continue AI/ML operation, that the WTRU may not continue AI/ML operation for a (e.g., given) functionality, that the WTRU may not continue AI/ML operation with a (e.g., given) model, that the WTRU may not continue AI/ML operation with the same performance and/or with a satisfactory performance (e.g., according to a preconfigured performance criteria), that the WTRU may not continue data collection, that the WTRU may not continue the connection (e.g., the WTRU may be released to IDLE/INACTIVE), and/or that the WTRU may not fulfill QoS requirements (e.g., latency, and/or reliability, etc.). The network may perform a confirmation action (e.g., as described herein), for example upon reception of the WTRU request for configuration adaptation by the network.

Configuration adaptation to support AI/ML operation under varying WTRU conditions is disclosed herein. A WTRU may adaptation of one or more configurations (e.g., upon activation of one or more AI/ML model(s) and/or functionality), for example to avoid negatively impacting the WTRU (e.g., causing the WTRU to overheat). An adaptation may be temporary (e.g., until any WTRU issue is resolved) or (e.g., more) permanent. Systems and methods herein may support adaptation of a (e.g., initial) configuration under varying WTRU condition. Additionally, or alternatively systems and methods herein may support (e.g., subsequent) confirmation, for example including handling and/or application of revised configurations (e.g., the application and configuration of adapted configurations) and/or support for temporary adaptation and configuration management after adaptation.

Confirmation and/or adaptation of a WTRU configuration is disclosed herein. A WTRU may autonomously apply a revised configuration and/or report to the network. The WTRU may apply the revised configuration implicitly (e.g., based on AI/ML LCM). In some examples the WTRU may receive confirmation prior to updating the WTRU configuration.

The WTRU may adapt a configuration for example autonomously, implicitly, and/or upon network confirmation. For example, a WTRU may be configured to autonomously adapt a configuration (e.g., upon satisfaction of a switching criteria as described herein). The WTRU may (e.g., then) inform the network. The WTRU may adapt the configuration, for example to avoid (e.g., critical) overheating and/or a low battery. The WTRU may implicitly adapt a configuration based on activation or deactivation of an associated AI/ML model and/or a functionality. The WTRU may transmit an indication and/or notification that the configuration may be adapted. The WTRU may (e.g., then) wait for network configuration. The WTRU may adapt a configuration, for example while waiting for confirmation from the network. The WTRU may continue operation according to the current configuration, for example while waiting for confirmation from the network. The WTRU may suspend AI/ML operation (e.g., inference, data collection, model transfer/training, performance monitoring etc.), for example while waiting for confirmation from the network. The WTRU may enter DRX, for example while waiting for confirmation from the network. The WTRU may suspend transmission and/or reception, for example while waiting for confirmation from the network.

The WTRU may confirm that the WTRU has applied the revised configuration (e.g., via the RRC Reconfiguration complete message), for example upon adaptation of a configuration. For example, the WTRU may send an indication that he WTRU has applied the configuration (e.g., to the network). In some examples the WTRU may not send a confirmation. The WTRU may determine that no (e.g., further confirmation) should be sent, for example upon reception of a network confirmation of the configuration adaptation.

The network may confirm application of a WTRU configuration adaptation. The network may confirm that a WTRU can apply an adapted configuration. The network may provide the confirmation in response to a WTRU indication that a trigger condition and/or adaptation criteria has been satisfied, and/or based on a request from the WTRU to adapt one or more WTRU configuration. For example, the WTRU may send a request (e.g., to the network) to apply a configuration. The network may send a response to the WTRU, for example indicating that the WTRU may apply the configuration. The network may determine (e.g., assume) that the WTRU may be operating with the revised configuration, for example upon reception of an WTRU indication and/or request, and/or a (e.g., subsequent) confirmation. In some examples the network may determine (e.g., assume) that the WTRU may be operating with the revised configuration after receiving a (e.g., additional) confirmation (e.g., an RRC reconfiguration complete message) (e.g., after network approval). The WTRU may continue to operate with a (e.g., previous) configuration, for example while the WTRU is waiting approval of the configuration adaptation.

The indication and/or request from the WTRU to apply an adapted configuration may not include another (e.g., second) configuration to apply and/or may include an outdated configuration to apply. The network may (e.g., then) respond with one or more configurations, for example for the WTRU to use to adapt the existing configuration. If the WTRU receives additional configuration information which conflicts with a stored configuration, the WTRU will replace the stored configuration with the latest configuration information.

The network may indicate an additional or alternative action for the WTRU to perform (e.g., other than accepting an adapted configuration). For example, the network may indicate deactivation of an AI/ML model and/or functionality, activation of an alternative AI/ML model and/or functionality (e.g., model switching), updated performance monitoring criteria, updated trigger conditions and/or criteria to adapt a WTRU configuration, a release to RRC IDLE and/or RRC INACTIVE, and/or a release of one or more configurations.

The network may reject the indication and/or request from the WTRU, for example by sending a response indicating that the WTRU may not apply the configuration. The WTRU may (e.g., therefore) not apply the adapted configuration and/or may continue with the current set of configurations, for example until subsequent reconfiguration and/or configuration failure. The WTRU may additionally or alternatively release the (e.g., relevant) configuration.

Configuration management post-adaptation is disclosed herein. The WTRU may perform (e.g., additional) actions after adaptation of one or more configurations, for example such that the configurations may address an issue (e.g., WTRU overheating, and/or performance degradation). The WTRU may adapt a configuration temporarily, for example until the WTRU issue (e.g., WTRU overheating, processing overload, and/or performance degradation) is addressed, and/or such that the revised configuration does not have a (e.g., overly) negative impact on WTRU performance.

The WTRU may be configured with a time duration, for example in which to apply the revised configuration. This time duration may be included as part of the configuration, or may be provided within a network notification accepting the configuration adaptation. The WTRU may start the time duration (e.g., via a timer), for example upon application of the adapted configuration. The WTRU may continue to use the adapted configuration during the duration. Additionally, or alternatively, the WTRU may revert to the original configuration upon completion of the duration.

The WTRU may monitor the performance of an associated AI/ML model and/or functionality, for example during the time duration. The WTRU may continue to use the configuration, for example If the performance remains the same or does not degrade by a (e.g., threshold) amount. The WTRU may continue to monitor performance indefinitely. In some examples the WTRU may determine (e.g., assume) that the adapted configuration is satisfactory and/or may continue with the adapted configuration until subsequent reconfiguration, for example upon completion of the duration. If the performance of the AI/ML model under the revised configuration falls below a configured threshold for example, the WTRU may adapt the configuration and/or request a configuration from the network.

The WTRU may be configured with conditions to revert to the primary or original configuration. For example, the WTRU may monitor for an associated configuration, functionality, and/or model deactivation. In some examples, the WTRU may monitor for an associated configuration, functionality, or model becoming non-applicable. In other examples, the WTRU may monitor for WTRU conditions which prompted the adaptation no longer being valid and/or applicable.

The WTRU may autonomously revert to the original condition, for example upon satisfaction of one or more of the conditions. Additionally, or alternatively, the WTRU may notify the network and/or continue to apply the adapted configuration (e.g., until subsequent network confirmation on which action the WTRU should undertake), for example upon satisfaction of one or more of the conditions.

Configuration management after configuration adaptation is disclosed herein. The WTRU may maintain the first and/or original configuration, for example upon applying an adapted configuration. In some examples the WTRU may release the first configuration upon application of the second configuration. In other examples the WTRU may release the first and/or original configuration based on the WTRU successfully completing a trial period, the WTRU performance being satisfactory, upon network instruction, upon handover, and/or upon release to RRC IDLE/INACTIVE.

The WTRU may be configured with time and/or location based conditions, for example in the case of using NTN. For example the WTRU may be configured with time and/or location based conditions when the WTRU location is within a threshold distance from a reference location. Additionally, or alternatively, the WTRU may be configured with time and/or location based conditions when the absolute time measured at the WTRU is within a time window (e.g. between T1 and T2).

A WTRU may adapt a configuration to support AI/ML operation under varying WTRU conditions. A WTRU may send an indication of a capability, for example to a network (e.g., base station). The indication may indicate (e.g., via WTRU capability signaling) a first and/or second set of capabilities, for example associated with a functionality (e.g., corresponding to different power requirements of different models). Example capabilities may include differences in DRX configuration, MaxCCs, MaxBW-FR1/FR2, and/or MaxMIMOLayersFR1/FR2.

The WTRU may report AI/ML functionality applicability, for example to the network. The WTRU may receive a configuration, for example associated with the functionality (e.g., inference, performance monitoring, and/or data collection, etc.). The WTRU may receive a first configuration (e.g., CC1, BW1, MIMO layers1 etc.) associated with the first set of capabilities (e.g., a “normal power” configuration). The WTRU may receive a second configuration (e.g., CC2, BW2, MIMO layers2 etc.) associated with a second set of capabilities (e.g., a “low power” configuration).

The WTRU may apply the (e.g., first) configuration associated with a first set of capabilities. The WTRU may report, for example via a RRC Reconfiguration complete message, that the WTRU is currently operating according to the first set of capabilities. The WTRU may store the second configuration associated with the second set of capabilities.

The WTRU may detect an event and/or change in WTRU status. The WTRU may (e.g., then) report that the WTRU may not continue applying AI/ML related configuration according to the first set of capabilities. Examples events and/or (e.g., WTRU) statuses may include overheating due to excessive power consumption, a low battery mode, overloaded computation, and/or a processing complexity, etc. The WTRU may alternatively or additionally indicate a preference to operate according to a second set of capabilities. For example the WTRU may indicate the preference to operate according to the second set of capabilities if the same performance or a similar is achievable by a lower-power model associated with second set. For example, the WTRU may compare a performance associated with a configuration to a performance associated with another configuration. The WTRU may determine that the performance associated with the (e.g., initial) configuration is the same or similar as the performance associated with the other configuration. For example, the performance associated with the (e.g., initial) configuration may be within a threshold of the performance associated with the other configuration. The WTRU may send (e.g., to the network) an indication of the determination (e.g., comparison) of the performance associated with the (e.g., initial) configuration and the performance associated with the other configuration. The WTRU may determine to apply the other configuration based on the comparison and/or the threshold.

The WTRU may receive a corresponding action from network, for example regarding AI/ML operation. For example the network may confirm that the WTRU may switch to the second configuration associated with the second set of capabilities. The network may provide the second configuration, for example if the second configuration is not already stored at WTRU. The network may switch, modify, and/or deactivate the AI/ML functionality. The WTRU may transmit a confirmation (e.g., via a RRC reconfiguration complete message) that the corresponding change in configuration has been applied.

1. A wireless transmit/receive unit (WTRU) comprising:
a processor, the processor configured to:
send an indication to a network entity that the WTRU is configured to support WTRU configuration adaptation related to one or more communication capabilities;
receive, in response to the indication, a plurality of configurations associated with the one or more communication capabilities;
apply a first configuration of the plurality of configurations associated with the one or more communication capabilities;
determine to change the first configuration based on a change in a WTRU status, wherein the WTRU status is associated with one or more of power or processing;
apply a second configuration of the plurality of configurations based on the determination to change the first configuration based on a change in a WTRU status associated with one or more of power or processing; and
send an indication that the second configuration has been applied to the network entity.

2. The WTRU of claim 1, wherein the one or more communication capabilities comprises a first communication capability and a second communication capability.

3. The WTRU of claim 2, wherein the first communication capability is associated with multiple input multiple output (MIMO) layers and the second communication capability is associated with a bandwidth (BW).

4. The WTRU of claim 2, wherein the first communication capability corresponds to a first artificial intelligence/machine learning (AI/ML) model functionality and the second communication capability corresponds to a second AI/ML model functionality, wherein the first AI/ML model functionality is different than the second AI/ML model functionality.

5. The WTRU of claim 1, wherein the plurality of configurations comprise one or more of a configuration for model training, a configuration for artificial intelligence/machine learning (AI/ML) model inference, a configuration for performance monitoring, a configuration for data collection, a configuration for applicability reporting, or a configuration for supporting WTRU operation.

6. The WTRU of claim 1, wherein the indication that the WTRU is configured to support WTRU configuration adaptation related to one or more communication capabilities comprises a first indication associated with a first capability of the WTRU and a second indication associated with a second capability of the WTRU, wherein the first capability and the second capability comprise different communication capabilities affecting one or more of processing or power.

7. The WTRU of claim 1, wherein the WTRU status comprises one or more of a heat of the WTRU, a power consumption of the WTRU, a battery level of the WTRU, or processing of the WTRU.

8. The WTRU of claim 1, wherein the processor configured to apply the second configuration based on the determination to change the first configuration comprises the processor being configured to change at least one value of the first configuration.

9. The WTRU of claim 1, wherein the processor configured to determine to change the first configuration based on the change in the WTRU status comprises the processor being configured to:
determine the change in the WTRU status; and
send, to a network, an indication of the determination of the change in the WTRU status.

10. The WTRU of claim 1, wherein the processor is configured to:
send, to the network, a request to apply the second configuration; and
receive, from the network, a response indicating that the WTRU can apply the second configuration.

11. A method implemented by a wireless transmit/receive unit (WTRU), the method comprising:
sending an indication to a network entity that the WTRU is configured to support WTRU configuration adaptation related to one or more communication capabilities;
receiving, in response to the indication, a plurality of configurations associated with the one or more communication capabilities;
applying a first configuration of the plurality of configurations associated with the one or more communication capabilities;
determining to change the first configuration based on a change in a WTRU status, wherein the WTRU status is associated with one or more of power or processing;
applying a second configuration of the plurality of configurations based on the determination to change the first configuration based on a change in a WTRU status associated with one or more of power or processing; and
sending an indication that the second configuration has been applied to the network entity.

12. The method of claim 11, wherein the one or more communication capabilities comprises a first communication capability and a second communication capability.

13. The method of claim 12, wherein the first communication capability is associated with multiple input multiple output (MIMO) layers and the second communication capability is associated with a bandwidth (BW).

14. The method of claim 12, wherein the first communication capability corresponds to a first artificial intelligence/machine learning (AI/ML) model functionality and the second communication capability corresponds to a second AI/ML model functionality, wherein the first AI/ML model functionality is different than the second AI/ML model functionality.

15. The method of claim 11, wherein the plurality of configurations comprise one or more of a configuration for model training, a configuration for artificial intelligence/machine learning (AI/ML) model inference, a configuration for performance monitoring, a configuration for data collection, a configuration for applicability reporting, or a configuration for supporting WTRU operation.

16. The method of claim 11, wherein the indication that the WTRU is configured to support WTRU configuration adaptation related to one or more communication capabilities comprises a first indication associated with a first capability of the WTRU and a second indication associated with a second capability of the WTRU, wherein the first capability and the second capability comprise different communication capabilities affecting one or more of processing or power.

17. The method of claim 11, wherein the WTRU status comprises one or more of a heat of the WTRU, a power consumption of the WTRU, a battery level of the WTRU, or processing of the WTRU.

18. The method of claim 11, wherein applying the second configuration based on the determination to change the first configuration comprises changing at least one value of the first configuration.

19. The method of claim 11, wherein determining to change the first configuration based on the change in the WTRU status comprises:
determining the change in the WTRU status; and
sending, to a network, an indication of the determination of the change in the WTRU status.

20. The method of claim 11, comprising:
sending, to the network, a request to apply the second configuration; and
receiving, from the network, a response indicating that the WTRU can apply the second configuration.
